(19) United States
(12) Patent Application Publication
(10) Pub. No.: US 2025/0380220 A1
(43) Pub. Date: Dec. 11, 2025

(54) METHOD AND APPARATUS FOR OPTIMIZING POWER CONSUMPTION

(71) Applicant: MEDIATEK INC., Hsinchu City (TW)

(72) Inventors: Kai-Wei OU, Hsinchu City (TW); Kai-Tai YANG, Hsinchu City (TW)

(21) Appl. No.: 19/221,922

(22) Filed: May 29, 2025

Related U.S. Application Data
(60) Provisional application No. 63/656,761, filed on Jun. 6, 2024.

(51) Int. Cl. H04W 52/02; H04W 68/02

(52) U.S. Cl. CPC H04W 52/0261; H04W 52/0225; H04W 68/02

(57) ABSTRACT

A method for optimizing power consumption is provided. The method is implemented by user equipment (UE) and includes receiving a configuration for Paging Early Indication (PEI), calculating first power consumption of the UE monitoring the PEI and second power consumption of the UE directly monitoring page messages during one or more paging occasions without monitoring the PEI based on the configuration for PEI and a paging rate of the UE and calculating a power penalty between the first power consumption and the second power consumption. The method includes comparing the power penalty to a predefined threshold and performing one of the following: stopping monitoring the PEI and directly monitoring the paging messages during the one or more paging occasions when the power penalty is greater than the predefined threshold, and continuing to monitor the PEI when the power penalty is less than or equal to the predefined threshold.

### CROSS REFERENCE TO RELATED APPLICATIONS

This application claims the benefit of U.S. Provisional Application No. 63/656,761, entitled “Algorithm for PEI Disable Mechanism”, filed on Jun. 6, 2024, the entirety of which is incorporated by reference herein.

### TECHNICAL FIELD

The present disclosure generally relates to wireless communication. More specifically, aspects of the present disclosure relate to a method and an apparatus for optimizing power consumption.

### BACKGROUND

Unless otherwise indicated herein, the approaches described in this section are not prior art to the claims listed below and are not admitted as prior art by inclusion in this section.

Third generation partnership project (3GPP) and 5G New Radio (NR) mobile telecommunication systems provide a high data rate, lower latency and improved system performance. In 3GPP NR, 5G terrestrial New Radio (NR) access network which includes a plurality of base stations, e.g., Next Generation Node-Bs (gNBs), communicating with a plurality of mobile stations referred as user equipment (UEs). Orthogonal Frequency Division Multiple Access (OFDMA) has been selected for NR downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE and NR networks, a Physical Downlink Control Channel (PDCCH) is used for downlink scheduling. A Physical Downlink Shared Channel (PDSCH) is used for downlink data. Similarly, a Physical Uplink Control Channel (PUCCH) is used for carrying uplink control information. A Physical Uplink Shared Channel (PUSCH) is used for uplink data. In addition, a physical random-access channel (PRACH) is used for non-contention-based RACH.

One important use of broadcast information in any cellular system is to set up channels for communication between the UE and the gNB. This is generally referred to as paging. Paging is a procedure the wireless network uses to find a UE, before the actual connection establishment. Paging is used to alert the UE of an incoming session (e.g., mobile terminated voice call, or downlink IP packets). In most cases, the paging process happens while UE is in radio resource control (RRC) idle mode or inactive mode. This means that UE has to monitor whether the networking is sending any paging message to it, and it has to spend some energy to run this “monitoring” process. During idle/inactive mode, a UE gets into and stays in sleeping mode defined in discontinuous reception (DRX) cycle. The UE periodically wakes up and monitors PDCCH to check for the presence of a paging message. If the PDCCH indicates that a paging message is transmitted in a subframe, then the UE demodulates the paging channel to see if the paging message is directed to it.

In NR, paging reception consumes less than 2.5% of the total power. However, due to the synchronization signal block (SSB) transmission scheme in NR, LOOP operations (including AGC, FTL, and TTL) and measurements (MEAS) can only be performed on certain occasions. As a result, the gap between the SSBs for LOOP/MEAS and paging occasion (PO) is longer, and the UE may enter a light sleep mode in the gap. If there is an indication before paging and the UE monitors PO only if the indication exists, then UE can save power not only for paging reception, but also for the light sleep between the last SSB and the PO gap.

In 5G system, paging early indication (PEI) notifies UEs of potentially relevant incoming paging such that these UEs are then able to skip POs in which the UEs are (definitely) not being paged, thus saving power (decoding POs being more power hungry than decoding PEI). To this effect, UE subgrouping is introduced that allows waking up subgroups of UEs for potentially relevant paging. The RAN and UE may use a Paging Early Indication with Paging Subgrouping (PEIPS) to reduce the UE's power consumption in RRC_IDLE and RRC_INACTIVE over NR. The Paging Subgrouping can be based on either the UE's temporary ID or a paging subgroup allocated by the AMF. Similar power saving features are also available in 4G EPS via the use of wakeup signals (WUS).

However, in some specific network configurations, the UE using the PEI may suffer from higher power consumption compared to the UE monitoring directly paging messages during the POs. The main reason for this higher power consumption is time distances among PEI occasions, SSB occasions, and POs.

FIG. 1 shows network configurations of Cases A-C from 0-59 millisecond (ms). In this embodiment, S represents the time slot where the UE performs pre-synchronizations, O represents the SSB occasions, E represents the PEI occasions and P represents the POs.

For Case A, the PEI indicates that the UE needs to monitor paging messages during the POs. For Case B, the PEI indicates that the UE skips monitoring paging messages during the POs. For Case C, the UE directly monitors the paging messages during POs without using the PEI. As shown in FIG. 1, the nearest time distance from S to E is 13, and the nearest time distance from O to P is only 3. The total power consumption of Cases A˜C are 2.311 unit, 1.901 unit and 1.602 unit, respectively. Obviously, the power consumption of the UE that only monitors the PEI is 2.311 unit or 1.901 unit, which is higher than the power consumption of the UE that monitors the paging messages during the POs, which is 1.602 unit.

There is a need to provide proper schemes to complete the goals for optimizing power consumption.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and an apparatus for optimizing power consumption are provided in the present disclosure. The main purpose of the disclosure is to determine scenarios where the UE may experience higher power consumption when monitoring the PEI instead of directly monitoring the paging occasion. When such a scenario occurs, the UE should stop monitoring the PEI and instead directly monitor the paging occasion to conserve power.

In an exemplary embodiment, a method for optimizing power consumption is provided. The method is implemented by a user equipment (UE) and comprises receiving a configuration for Paging Early Indication (PEI) from a base station. The method includes calculating first power consumption of the UE monitoring the PEI and second power consumption of the UE directly monitoring page messages during one or more paging occasions without monitoring the PEI based on the configuration for PEI and a paging rate of the UE. The method includes calculating a power penalty between the first power consumption and the second power consumption. The method includes comparing the power penalty to a predefined threshold. The method includes performing one of the following: stopping monitoring the PEI and directly monitoring the paging messages during the one or more paging occasions when the power penalty is greater than the predefined threshold; and continuing to monitor the PEI when the power penalty is less than or equal to the predefined threshold.

In some implementations, the configuration for PEI at least comprises a number of paging subgroups per paging occasion and time distances between a Synchronization Signal Block (SSB) and the one or more paging occasions, the SSB and the PEI, and the one or more paging occasions and the PEI.

In some implementations, the power penalty P is calculated as follows:

$$P = {Power}_{P E I} - {Power}_{PO \_ only} ,$$

wherein Power_{PEI} is the first power consumption and Power_{PO_only} is the second power consumption.

In some implementations, the first power consumption Power_{PEI} is calculated as follows:

$${Power}_{P E I} = \frac{R}{N} \times {Power}_{PEI \_ PO} + ( 1 - \frac{R}{N} ) \times {Power}_{PEI \_ only} ,$$

wherein R is the paging rate of the UE, N is the number of paging subgroups per paging occasion, Power_{PEI_PO} is third power consumption required by the UE when the PEI indicates that the UE needs to monitor the paging messages during the one or more paging occasions, and Power_{PEI_only} is fourth power consumption required by the UE when the PEI indicates that the UE skips monitoring the paging messages during the one or more paging occasions.

In some implementations, the paging rate of the UE is calculated by the UE.

In some implementations, the paging rate of the UE is not a fixed value.

In some implementations, the predefined threshold is 0.

In some implementations, the method further comprises periodically calculating the paging rate to update the power penalty.

In an exemplary embodiment, an apparatus for optimizing power consumption is provided. The apparatus comprises a transceiver and a processor. The transceiver which, during operation, wirelessly communicates with at least one base station. The processor communicatively coupled to the transceiver such that, during operation, the processor performs operations comprising receiving a configuration for Paging Early Indication (PEI) from a base station. The processor performs operations comprising calculating first power consumption of the apparatus monitoring the PEI and second power consumption of the apparatus directly monitoring page messages during one or more paging occasions without monitoring the PEI based on the configuration for PEI and a paging rate of the apparatus. The processor performs operations comprising calculating a power penalty between the first power consumption and the second power consumption. The processor performs operations comprising comparing the power penalty to a predefined threshold. The processor performs operations comprising performing one of the following: stopping monitoring the PEI and directly monitoring the paging messages during the one or more paging occasions when the power penalty is greater than the predefined threshold; and continuing to monitor the PEI when the power penalty is less than or equal to the predefined threshold.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 shows network configurations of Cases A-C from 0-59 millisecond (ms).

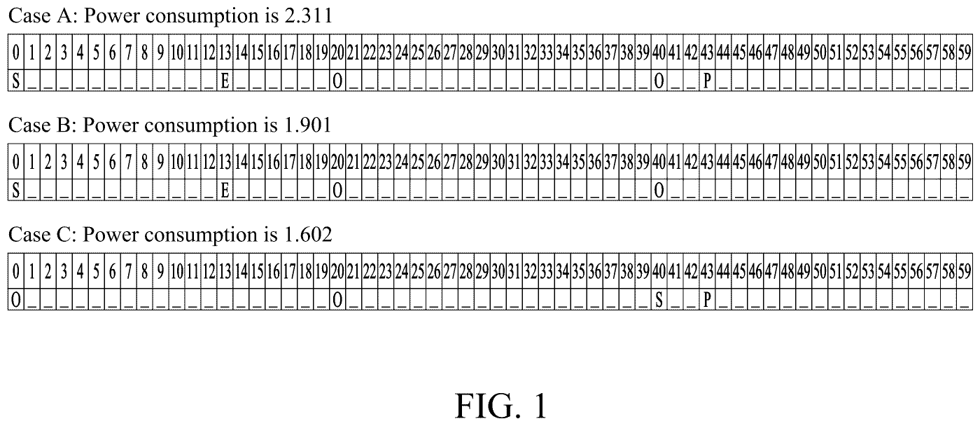

FIG. 2 illustrates how the UE decides to monitor or stop monitoring PEI according to an implementation of the present disclosure

FIG. 3 is a block diagram of an example communication system in accordance with an implementation of the present disclosure.

FIG. 4 is a flowchart of an example process in accordance with an implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network functions or algorithms described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network functions or algorithms. The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, a 5G New Radio (NR) Radio Access Network (RAN) or a 6G NR RAN) typically includes at least one Base Station (BS), at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through a RAN established by one or more BSs.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), 6G and/or LTE-A Pro. However, the scope of the present disclosure should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides service to one or more UEs within its radio coverage (e.g., each cell schedules the downlink and optionally uplink resources to at least one UE within its radio coverage for downlink and optionally uplink packet transmissions). The BS can communicate with one or more UEs in the radio communication system through the plurality of cells. A cell may allocate Sidelink (SL) resources for supporting Proximity Service (ProSe) or Vehicle to Everythinag (V2X) service. Each cell may have overlapping coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and an Uplink (UL) transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects and represents that three relationships may exist. For example, A and/or B may indicate that: A exists alone, A and B exist at the same time, or B exists alone. In addition, the character “/” herein generally represents that the former and latter associated objects are in an “or” relationship.

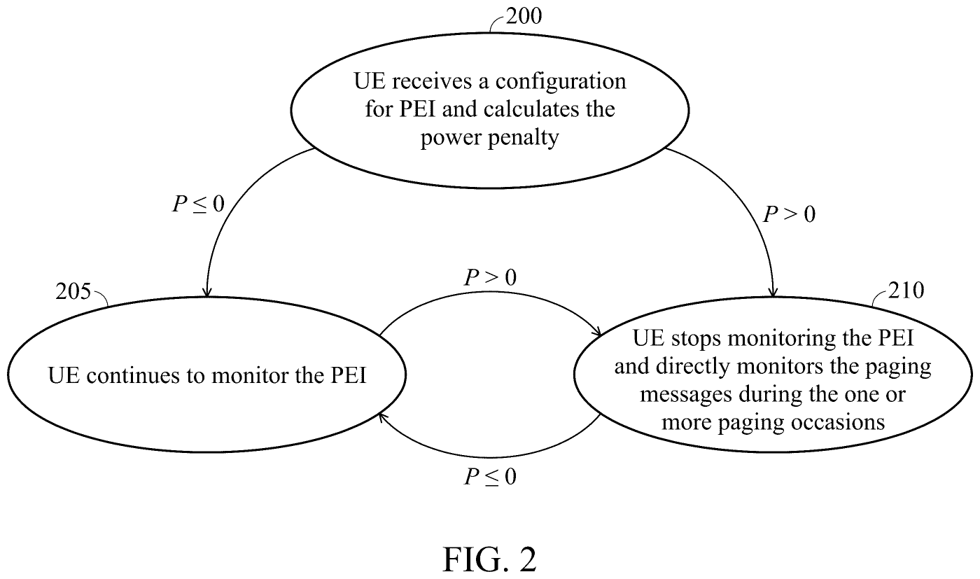

FIG. 2 illustrates how the UE decides to monitor or stop monitoring PEI according to an implementation of the present disclosure.

In the initial state 200, the UE receives a configuration for Paging Early Indication (PEI) from a base station, calculates first power consumption of the UE monitoring the PEI and second power consumption of the UE directly monitoring page messages during one or more Paging Occasions (POs) without monitoring the PEI based on the configuration for PEI and a paging rate of the UE, and calculates a power penalty between the first power consumption and the second power consumption.

In some implementations, the configuration for PEI at least comprises a number of paging subgroups per paging occasion and time distances between a Synchronization Signal Block (SSB) and the one or more paging occasions, the SSB and the PEI, and the one or more paging occasions and the PEI, wherein the UE is one of the first UEs and belongs to the paging subgroup. Specifically, a paging subgroup is a subgroup of a group of UEs associated with a paging occasion and the group of UEs can be paged by the base station in the paging occasion. The paging subgroup can be grouped by the base station based on different criteria, e.g., power consumption profiled (PCP), or paging probability.

In some implementations, the paging rate of the UE is calculated by the UE and is not a fixed value. In another implementation, the UE may periodically calculate the paging rate to update the power penalty. In some implementations, the paging rate may be periodically calculated based on a system frequency, a configuration setting or an event. In some implementations, the power penalty P is calculated as follows:

$$P = {Power}_{P E I} - {Power}_{PO \_ only} ,$$

wherein Power_{PEI} is the first power consumption, Power_{PO_only} is the second power consumption. The first power consumption Power_{PEI} is calculated as follows:

$${Power}_{P E I} = \frac{R}{N} \times {Power}_{PEI \_ PO} + ( 1 - \frac{R}{N} ) \times {Power}_{PEI \_ only}$$

wherein R is the paging rate of the UE, N is the number of paging subgroups per paging occasion, Power_{PEI_PO} is the third power consumption required by the UE when the PEI indicates that the UE needs to monitor the paging messages during the one or more paging occasions, and Power_{PEI_only} is the fourth power consumption required by the UE when the PEI indicates that the UE skips monitoring the paging messages during the one or more paging occasions.

Then, the UE compares the power penalty to a predefined threshold, wherein the predefined threshold is 0. When the power penalty is less than or equal to the predefined threshold, the UE transfers from state 200 to state 205 and continues to monitor the PEI. When the power penalty is greater than the predefined threshold, the UE transfers from state 200 to state 210. In state 210, the UE stops monitoring the PEI and directly monitors the paging messages during the one or more paging occasions to save power.

Since the paging rate is not a fixed value, the power penalty may also be updated when the paging rate changes. The UE may switch between state 205 and state 210 according to the updated power penalty. For example, when the UE is in state 205, the UE transfers from state 205 to state 210 when the power penalty updated by the UE is greater than the predefined threshold. When the UE is in state 210, the UE transfers from state 210 to state 205 when the power penalty updated by the UE is less than or equal to the predefined threshold.

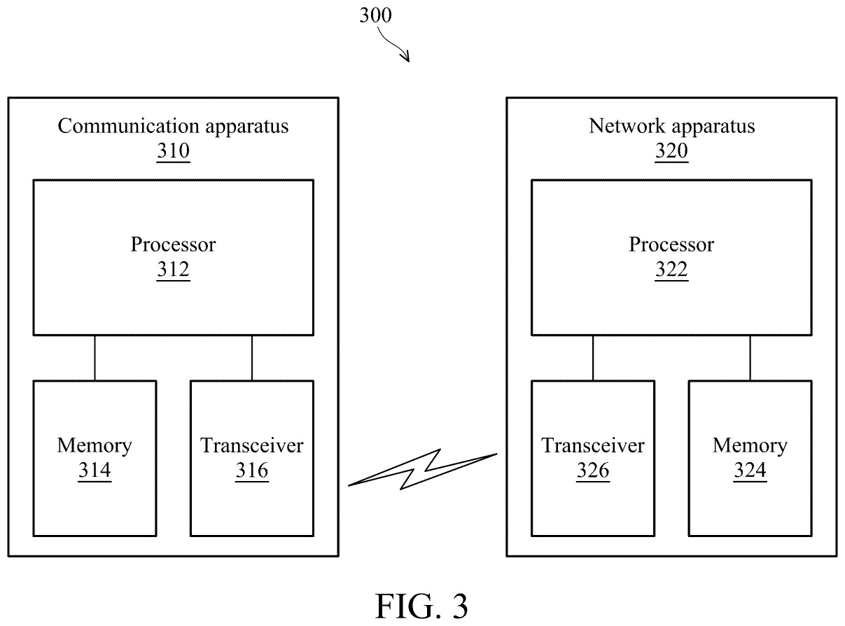

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to optimize power consumption, including scenarios/schemes described above as well as process 400 described below.

The communication apparatus 310 may be a part of an electronic apparatus, which may be a UE such as a portable or mobile apparatus, a wearable apparatus, a wireless communication apparatus or a computing apparatus. For instance, the communication apparatus 310 may be implemented in a smartphone, a smartwatch, a personal digital assistant, a digital camera, or a computing equipment such as a tablet computer, a laptop computer or a notebook computer. The communication apparatus 310 may also be a part of a machine type apparatus, which may be an IoT, NB-IoT, or IIOT apparatus such as an immobile or a stationary apparatus, a home apparatus, a wire communication apparatus or a computing apparatus. For instance, the communication apparatus 310 may be implemented in a smart thermostat, a smart fridge, a smart door lock, a wireless speaker or a home control center. Alternatively, the communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 310 may include at least some of those components shown in FIG. 3 such as a processor 312, for example. The communication apparatus 310 may further include one or more other components not pertinent to the proposed scheme of the present disclosure (e.g., internal power supply, display device and/or user interface device), and, thus, such component(s) of the communication apparatus 310 are neither shown in FIG. 3 nor described below in the interest of simplicity and brevity.

The network apparatus 320 may be a part of an electronic apparatus, which may be a network node such as a BS, a small cell, a router or a gateway. For instance, the network apparatus 320 may be implemented in a gNB in a 5G, B5G, 6G, IoT, NB-IoT or IIOT network. Alternatively, the network apparatus 320 may be implemented in the form of one or more IC chips such as, for example and without limitation, one or more single-core processors, one or more multi-core processors, or one or more RISC or CISC processors. The network apparatus 320 may include at least some of those components shown in FIG. 3 such as a processor 322, for example. The network apparatus 320 may further include one or more other components not pertinent to the proposed scheme of the present disclosure (e.g., internal power supply, display device and/or user interface device), and, thus, such component(s) of the network apparatus 320 are neither shown in FIG. 3 nor described below in the interest of simplicity and brevity.

In one aspect, each of the processor 312 and the processor 322 may be implemented in the form of one or more single-core processors, one or more multi-core processors, or one or more CISC processors. That is, even though a singular term “a processor” is used herein to refer to the processor 312 and the processor 322, each of the processor 312 and the processor 322 may include multiple processors in some implementations and a single processor in other implementations in accordance with the present disclosure. In another aspect, each of the processor 312 and the processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and the processor 322 is a special-purpose machine specifically designed, arranged and configured to perform specific tasks including an operation for optimizing power consumption in a UE (e.g., as represented by the communication apparatus 310) and a BS (e.g., as represented by the network apparatus 320) in accordance with various implementations of the present disclosure.

In some implementations, the communication apparatus 310 may also include a transceiver 316 coupled to the processor 312 and capable of wirelessly transmitting and receiving control and data signals. In some implementations, the transceiver 316 may be capable of wirelessly communicating with different types of gNBs of different RATs. In some implementations, the transceiver 316 may be equipped with a plurality of antenna ports (not shown) such as, for example, four antenna ports. That is, the transceiver 316 may be equipped with multiple transmit antennas and multiple receive antennas for multiple-input multiple-output (MIMO) wireless communications. In some implementations, the network apparatus 320 may also include a transceiver 326 coupled to the processor 322 and capable of wirelessly transmitting and receiving control and data signals. In some implementations, the transceiver 326 may be capable of wirelessly communicating with different types of UEs of different RATs. In some implementations, the transceiver 326 may be equipped with a plurality of antenna ports (not shown) such as, for example, four antenna ports. That is, the transceiver 326 may be equipped with multiple transmit antennas and multiple receive antennas for MIMO wireless communications. Accordingly, the communication apparatus 310 and the network apparatus 320 may wirelessly communicate with each other via the transceiver 316 and transceiver 326, respectively.

In some implementations, the communication apparatus 310 may further include a memory 314 coupled to the processor 312 and capable of being accessed by processor 312 and storing data therein. In some implementations, the network apparatus 320 may further include a memory 324 coupled to the processor 322 and capable of being accessed by the processor 322 and storing data therein. Each of the memory 314 and the memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of the memory 314 and the memory 324 may include a type of read-only memory (ROM) such as mask ROM, programmable ROM (PROM), erasable programmable ROM (EPROM) and/or electrically erasable programmable ROM (EEPROM). Alternatively, or additionally, each of the memory 314 and the memory 324 may include a type of non-volatile random-access memory (NVRAM) such as flash memory, solid-state memory, ferroelectric RAM (FeRAM), magnetoresistive RAM (MRAM) and/or phase-change memory.

Each of the communication apparatus 310 and the network apparatus 320 may be a communication entity capable of communicating with each other using various proposed schemes in accordance with the present disclosure. For illustrative purposes and without limitation, a description of operations, functionalities, and capabilities of the communication apparatus 310, implemented in or as a UE (e.g., the UE in FIG. 2), and the network apparatus 320, implemented in or as a base station, is provided below.

According to certain proposed schemes of the present disclosure, the processor 312 of the communication apparatus 310 may receive, via the transceiver 316, a configuration for Paging Early Indication (PEI) from the network apparatus 320. Specifically, the PEI at least comprises a number of paging subgroups per paging occasion and time distances between a Synchronization Signal Block (SSB) and the one or more paging occasions, the SSB and the PEI, and the one or more POs and the PEI. Then, the processor 312 may calculate first power consumption of the communication apparatus 310 monitoring the PEI and second power consumption of the communication apparatus 310 directly monitoring page messages during one or more paging occasions without monitoring the PEI based on the configuration for PEI and a paging rate of the communication apparatus 310. Next, the processor 312 may calculate a power penalty between the first power consumption and the second power consumption. The processor 312 may compare the power penalty to a predefined threshold and perform one of the following actions: stopping monitoring the PEI and directly monitoring the paging messages during the one or more paging occasions when the power penalty is greater than the predefined threshold, and continuing to monitor the PEI when the power penalty is less than or equal to the predefined threshold.

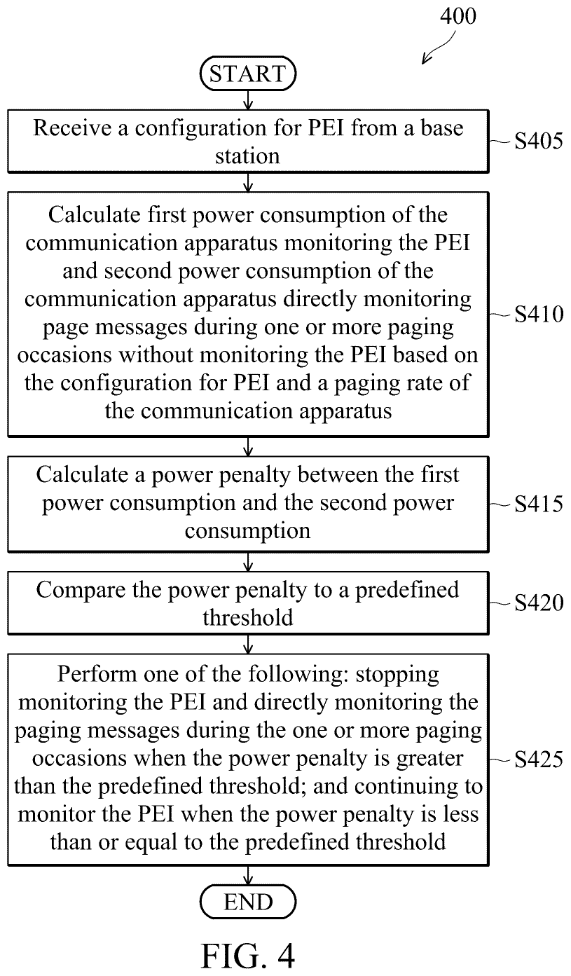

FIG. 4 illustrates an example process 400 in accordance with an implementation of the present disclosure. The process 400 may be an example implementation of above scenarios/schemes, whether partially or completely, with respect to the method for optimizing power consumption. The process 400 may represent an aspect of implementation of features of the communication apparatus 310. The process 400 may include one or more operations, actions, or functions as illustrated by one or more of block S405, S410, S415, S420 and S425. Although illustrated as discrete blocks, various blocks of the process 400 may be divided into additional blocks, combined into fewer blocks, or eliminated, depending on the desired implementation. Moreover, the blocks of the process 400 may be executed in the order shown in FIG. 4 or, alternatively, in a different order. The process 400 may be implemented by the communication apparatus 310 or any suitable UE. Solely for illustrative purposes and without limitation, the process 400 is described below in the context of the communication apparatus 310 as a UE and the network apparatus 320 as a network or a BS. The process 400 may begin at block S405.

In S405, the process 400 may involve the processor 312 of the communication apparatus 310 receiving, via the transceiver 316, a configuration for Paging Early Indication (PEI) from a base station, wherein the configuration for PEI at least comprises the number of paging subgroups per paging occasion and time distances between a Synchronization Signal Block (SSB) and the one or more paging occasions, the SSB and the PEI, and the one or more POs and the PEI. The process 400 may proceed from S405 to S410.

In S410, the process 400 may involve the processor 312 of the communication apparatus 310 calculating first power consumption of the communication apparatus 310 monitoring the PEI and second power consumption of the communication apparatus 310 directly monitoring page messages during one or more paging occasions without monitoring the PEI based on the configuration for PEI and the paging rate of the communication apparatus 310. The process 400 may proceed from S610 to S415.

In S415, the process 400 may involve the processor 312 of the communication apparatus 310 calculating a power penalty between the first power consumption and the second power consumption. The process 400 may proceed from S415 to S420.

In step S420, the process 400 may involve the processor 312 of the communication apparatus 310 comparing the power penalty to a predefined threshold. The process 400 may proceed from S420 to $415.

In step S425, the process 400 may involve the processor 312 of the communication apparatus 310 performing one of the following: stopping monitoring the PEI and directly monitoring the paging messages during the one or more paging occasions when the power penalty is greater than the predefined threshold and continuing to monitor the PEI when the power penalty is less than or equal to the predefined threshold.

In some implementations, the paging rate of the communication apparatus 310 is calculated by the communication apparatus 310, and the paging rate of the communication apparatus 310 is not a fixed value.

In some implementations, the predefined threshold is 0.

In some implementations, the power penalty P is calculated as follows:

$$P = {Power}_{P E I} - {Power}_{PO \_ only} ,$$

wherein Power_{PEI} is the first power consumption and Power_{PO_only} is the second power consumption. The first power consumption Power_{PEI} is calculated as follows:

$${Power}_{P E I} = \frac{R}{N} \times {Power}_{PEI \_ PO} + ( 1 - \frac{R}{N} ) \times {Power}_{PEI \_ only} ,$$

wherein R is the paging rate of the UE, N is the number of paging subgroups per paging occasion, Power_{PEI_PO} is third power consumption required by the communication apparatus 310 when the PEI indicates that the communication apparatus 310 needs to monitor the paging messages during the one or more paging occasions, and Power_{PEI_only} is fourth power consumption required by the communication apparatus 310 when the PEI indicates that the communication apparatus 310 skips monitoring the paging messages during the one or more paging occasions.

In some implementations, the process 400 may involve the processor 312 of the communication apparatus 310 periodically calculating the paging rate to update the power penalty.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for optimizing power consumption, wherein the method is implemented by a user equipment (UE), and comprises:
receiving a configuration for Paging Early Indication (PEI) from a base station;
calculating first power consumption of the UE monitoring the PEI and second power consumption of the UE directly monitoring page messages during one or more paging occasions without monitoring the PEI based on the configuration for PEI and a paging rate of the UE;
calculating a power penalty between the first power consumption and the second power consumption;
comparing the power penalty to a predefined threshold; and
performing one of the following:
stopping monitoring the PEI and directly monitoring the paging messages during the one or more paging occasions when the power penalty is greater than the predefined threshold; and
continuing to monitor the PEI when the power penalty is less than or equal to the predefined threshold.

2. The method for optimizing power consumption as claimed in claim 1, wherein the configuration for PEI at least comprises a number of paging subgroups per paging occasion and time distances between a Synchronization Signal Block (SSB) and the one or more paging occasions, the SSB and the PEI, and the one or more paging occasions and the PEI.

3. The method for optimizing power consumption as claimed in claim 2, wherein the power penalty P is calculated as follows:
$$P = {Power}_{P E I} - {Power}_{P {O}_{o n l y}} ,$$
wherein Power_{PEI} is the first power consumption and Power_{PO_only} is the second power consumption.

4. The method for optimizing power consumption as claimed in claim 3, wherein the first power consumption Power_{PEI} is calculated as follows:
$${Power}_{P E I} = \frac{R}{N} \times {Power}_{{PEI}_{PO}} + ( 1 - \frac{R}{N} ) \times {Power}_{P E {I}_{o n l y}} ,$$
wherein R is the paging rate of the UE, N is the number of paging subgroups per paging occasion, Power_{PEI_PO} is third power consumption required by the UE when the PEI indicates that the UE needs to monitor the paging messages during the one or more paging occasions, and Power_{PEI_only} is fourth power consumption required by the UE when the PEI indicates that the UE skips monitoring the paging messages during the one or more paging occasions.

5. The method for optimizing power consumption as claimed in claim 1, wherein the paging rate of the UE is calculated by the UE.

6. The method for optimizing power consumption as claimed in claim 1, wherein the paging rate of the UE is not a fixed value.

7. The method for optimizing power consumption as claimed in claim 1, wherein the predefined threshold is 0.

8. The method for optimizing power consumption as claimed in claim 1, further comprising:
periodically calculating the paging rate to update the power penalty.

9. An apparatus for optimizing power consumption, comprising:
a transceiver which, during operation, wirelessly communicates with at least one base station; and
a processor communicatively coupled to the transceiver such that, during operation, the processor performs operations comprising:
receiving a configuration for Paging Early Indication (PEI) from a base station;
calculating first power consumption of the apparatus monitoring the PEI and second power consumption of the apparatus directly monitoring page messages during one or more paging occasions without monitoring the PEI based on the configuration for PEI and a paging rate of the apparatus;
calculating a power penalty between the first power consumption and the second power consumption;
comparing the power penalty to a predefined threshold; and
performing one of the following:
stopping monitoring the PEI and directly monitoring the paging messages during the one or more paging occasions when the power penalty is greater than the predefined threshold; and
continuing to monitor the PEI when the power penalty is less than or equal to the predefined threshold.

10. The apparatus for optimizing power consumption as claimed in claim 9, wherein the configuration for PEI at least comprises a number of paging subgroups per paging occasion and time distances between a Synchronization Signal Block (SSB) and the one or more paging occasions, the SSB and the PEI, and the one or more paging occasions and the PEI.

11. The apparatus for optimizing power consumption as claimed in claim 10, wherein the power penalty P is calculated as follows:
$$P = {Power}_{P E I} - {Power}_{P {O}_{o n l y}} ,$$
wherein Power_{PEI} is the first power consumption and Power_{PO_only} is the second power consumption.

12. The method for optimizing power consumption as claimed in claim 11, wherein the first power consumption Power_{PEI} is calculated as follows:
$${Power}_{P E I} = \frac{R}{N} \times {Power}_{{PEI}_{PO}} + ( 1 - \frac{R}{N} ) \times {Power}_{P E {I}_{o n l y}} ,$$
wherein R is the paging rate of the apparatus, N is the number of paging subgroups per paging occasion, Power_{PEI_PO} is third power consumption required by the apparatus when the PEI indicates that the apparatus needs to monitor the paging messages during the one or more paging occasions, and Power_{PEI_only} is fourth power consumption required by the apparatus when the PEI indicates that the apparatus skips monitoring the paging messages during the one or more paging occasions.

13. The apparatus for optimizing power consumption as claimed in claim 9, wherein the paging rate of the apparatus is calculated by the apparatus.

14. The apparatus for optimizing power consumption as claimed in claim 9, wherein the paging rate of the apparatus is not a fixed value.

15. The apparatus for optimizing power consumption as claimed in claim 9, wherein the predefined threshold is 0.

16. The apparatus for optimizing power consumption as claimed in claim 9, wherein the processor further performs operations comprising:
periodically calculating the paging rate to update the power penalty.
